(19) United States
(12) Patent Application Publication
(10) Pub. No.: US 2022/0157323 A1
(43) Pub. Date: May 19, 2022

(54) SYSTEM AND METHODS FOR INTELLIGENT TRAINING OF VIRTUAL VOICE ASSISTANT

(71) Applicant: BANK OF AMERICA CORPORATION, Charlotte, NC (US)

(72) Inventors: Sandeep Verma, Gurugram (IN); Pavan Chayanam, Alamo, CA (US); Srinivas Dundigalla, Charlotte, NC (US); Nandini Rathaur, Hyderabad (IN); Rama Yannam, Plano, TX (US)

(73) Assignee: BANK OF AMERICA CORPORATION, Charlotte, NC (US)

(21) Appl. No.: 17/098,652

(22) Filed: Nov. 16, 2020

(51) Int. Cl. G10L 17/10; G06N 20/00; G06F 9/451; G10L 17/04

(52) U.S. Cl. CPC G10L 17/10; G06N 20/00; G10L 2015/228; G10L 17/04; G06F 9/453

(57) ABSTRACT

Embodiments of the present invention provide systems and methods for using machine learning to analyze and infer the contextual significance of a conversational language in order to proactively engage with one or more users in a familiar manner via a virtual voice assistant. As such, the systems and methods reduce redundancy of process steps for the user in accessing relevant information or initiating certain resource activities via disparate channels of communication by creating a continuity of conversational tone and substance.

### FIELD OF THE INVENTION

The present invention is generally related to systems and methods for generating intelligent and adaptable virtual voice assistant using multi-channel data. Multiple devices may be utilized by the multi-channel resource system in order to receive and process data to complete anticipate and respond to user needs.

### BACKGROUND

Existing systems require a user to navigate multiple applications and potentially perform numerous redundant actions to execute electronic resource activities or source responsive data to their support needs. Furthermore, execution of the electronic activities requires the user to be adept with various distinct functions and technology elements of a myriad applications in order to retrieve certain information. As such, conducting electronic activities on electronic devices to retrieve desired information or authorize resource transfers or access system support or functionality is often time consuming, cumbersome and unwieldy. There is a need for an intelligent, proactive and responsive system that facilitates execution of electronic activities in an integrated manner, and which is capable of adapting to the user's natural communication and its various modes in order to anticipate and provide relevant, helpful information to the user.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later. Embodiments of the present invention address these and/or other needs by providing a system for authorization of resource allocation, distribution or transfer based on multi-channel inputs that is configured for intelligent, proactive and responsive communication with a user, via a user device. The system is further configured to perform one or more user activities, in an integrated manner, within a single interface of the user device, without requiring the user to operate disparate applications. Furthermore, the system is configured to receive user input through multiple communication channels such as a textual communication channel and an audio communication channel and store unique user patterns to form an authentication baseline for subsequent user communications. The system is further configured to switch between the various communication channels seamlessly, and in real-time. In some instances, the system comprises: at least one memory device with computer-readable program code stored thereon, at least one communication device, at least one processing device operatively coupled to the at least one memory device and the at least one communication device, wherein executing the computer-readable program code is typically configured to cause the at least one processing device to perform, execute or implement one or more features or steps of the invention.

Embodiments of the invention relate to systems, computer implemented methods, and computer program products for establishing intelligent, proactive and responsive communication with a user, comprising a multi-channel user input platform for performing electronic activities in an integrated manner from a single interface, the invention comprising: providing a multi-channel resource application on a user device associated with a user, wherein the multi-channel resource application is configured to present a central user interface on a display device of the user device; receiving a first set of user input data via a first data channel; analyzing the first set of user input data via a machine learning engine and generate a voice data classification key for the user; receiving a second set of user input data via a second channel; mapping the second set of user input data to the first set of user input data to determine contextual significance and generate a software service call for the contextual significance; receiving a third set of user input data via third communication channel from the user device; identifying a previously stored software service call relating to the third set of user input data; and providing a contextualized response to the third set of user input data via the multi-channel resource application on the user device.

In some embodiments, the first data channel is an audio communication channel established via a conversation voice data tunnel between the user and the multi-channel intelligent virtual assistant.

In some embodiments, the second data channel is a software input data channel established via a software code navigation data tunnel between a second user and a contextual artificial intelligence model.

In some embodiments, the third data channel is a text communication channel established via the user device and a remote virtual assistant processing engine.

In some embodiments, the voice data classification key further comprises a data store of unique frequency patterns of logged audio data received from the user as determined by analysis via a machine learning engine.

In some embodiments, the contextualized response to the third set of user input data is further based on extrapolated inferences of user preferences based on a set of user data of multiple users sharing one or more characteristics with the user.

In some embodiments, multi-channel intelligent virtual assistant is stored on a remote server and provided via the user device as a cloud-based service.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts a system environment 100 providing a system for multi-channel user input, in accordance with one embodiment of the present invention;

FIG. 2 provides a block diagram of the user device 104, in accordance with one embodiment of the invention;

FIG. 3 depicts a process flow of a language processing module 200, in accordance with one embodiment of the present invention;

FIG. 4 depicts a high-level process flow 300 for intelligent voice assistant training, in accordance with one embodiment of the present invention; and

FIG. 5 depicts a high-level process flow 400 for intelligent voice assistant implementation, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In some embodiments, an “entity” or “enterprise” as used herein may be any institution or establishment, associated with a network connected resource transfer platform, and particularly geolocation systems and devices. As such, the entity may be any institution, group, association, financial institution, merchant, establishment, company, union, authority or the like.

As described herein, a “user” is an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

In the instances where the entity is a resource entity or a merchant, financial institution and the like, a user may be an individual or entity with one or more relationships, affiliations or accounts with the entity (for example, the merchant, the financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution. For purposes of this invention, the term “user” and “customer” may be used interchangeably. A “technology resource” or “account” may be the relationship that the user has with the entity. Examples of technology resources include a deposit account, such as a transactional account (e.g. a banking account), a savings account, an investment account, a money market account, a time deposit, a demand deposit, a pre-paid account, a credit account, a non-monetary user datastore that includes only personal information associated with the user, or the like. The technology resource or account is typically associated with and/or maintained by an entity, and is typically associated with technology infrastructure such that the resource or account may be accessed, modified or acted upon by the user electronically, for example using or transaction terminals, user devices, merchant systems, and the like. In some embodiments, the entity may provide one or more technology instruments or financial instruments to the user for executing resource transfer activities or financial transactions. In some embodiments, the technology instruments/financial instruments like electronic tokens, credit cards, debit cards, checks, loyalty cards, entity user device applications, account identifiers, routing numbers, passcodes and the like are associated with one or more resources or accounts of the user. In some embodiments, an entity may be any institution, group, association, club, establishment, company, union, authority or the like with which a user may have a relationship. As discussed, in some embodiments, the entity represents a vendor or a merchant with whom the user engages in financial (for example, resource transfers like purchases, payments, returns, enrolling in merchant accounts and the like) or non-financial transactions (for resource transfers associated with loyalty programs and the like), either online or in physical stores.

As used herein, a “user interface” may be a graphical user interface that facilitates communication using one or more communication mediums such as tactile communication (such, as communication via a touch screen, keyboard, and the like), audio communication, textual communication and/or video communication (such as, gestures). Typically, a graphical user interface (GUI) of the present invention is a type of interface that allows users to interact with electronic elements/devices such as graphical icons and visual indicators such as secondary notation, as opposed to using only text via the command line. That said, the graphical user interfaces are typically configured for audio, visual and/or textual communication, and are configured to receive input and/or provide output using one or more user device components and/or external auxiliary/peripheral devices such as a display, a speaker, a microphone, a touch screen, a camera, a GPS device, a keypad, a mouse, and/or the like. In some embodiments, the graphical user interface may include both graphical elements and text elements. The graphical user interface is configured to be presented on one or more display devices associated with user devices, entity systems, auxiliary user devices, processing systems and the like.

An electronic activity, also referred to as a “technology activity” or a “user activity”, such as a “resource transfer” or “transaction”, may refer to any activities or communication between a user or entity and the financial institution, between the user and the entity, activities or communication between multiple entities, communication between technology applications and the like. A resource transfer may refer to a payment, processing of funds, purchase of goods or services, a return of goods or services, a payment transaction, a credit transaction, or other interactions involving a user's resource or account. In the context of a financial institution or a resource entity such as a merchant, a resource transfer may refer to one or more of: transfer of resources/funds between financial accounts (also referred to as “resources”), deposit of resources/funds into a financial account or resource (for example, depositing a check), withdrawal of resources or finds from a financial account, a sale of goods and/or services, initiating an automated teller machine (ATM) or online banking session, an account balance inquiry, a rewards transfer, opening a bank application on a user's computer or mobile device, a user accessing their e-wallet, applying one or more promotions/coupons to purchases, or any other interaction involving the user and/or the user's device that invokes or that is detectable by or associated with the financial institution. A resource transfer may also include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer,” a “transaction,” a “transaction event,” or a “point of transaction event,” refers to any user activity (financial or non-financial activity) initiated between a user and a resource entity (such as a merchant), between the user and the financial instruction, or any combination thereof.

In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a funds/resource transfer between account, funds/resource transfer as a payment for the purchase for a product, service, or the like from a merchant, and the like. Typical financial transactions or resource transfers include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures, and the like.

In accordance with embodiments of the invention, the term “user” may refer to a merchant or the like, who utilizes an external apparatus such as a user device, for retrieving information related to the user's business that the entity may maintain or compile. Such information related to the user's business may be related to resource transfers or transactions that other users have completed using the entity systems. The external apparatus may be a user device (computing devices, mobile devices, smartphones, wearable devices, and the like). In some embodiments, the user may seek to perform one or more user activities using a multi-channel cognitive resource application of the invention, or user application, which is stored on a user device. In some embodiments, the user may perform a query by initiating a request for information from the entity using the user device to interface with the system for adjustment of resource allocation based on multi-channel inputs in order to obtain information relevant to the user's business.

In accordance with embodiments of the invention, the term “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

In accordance with embodiments of the invention, the term “voice assistant” or “virtual assistant” may refer to a system or method of communicating with the user via a user device in order to respond to user requests or provide information. In some embodiments, the information provided to the user by the virtual assistant may be related to customer service topics, while in other embodiments the information provided to the user may be related to resource transfer, resource balance updates, alerts, auxiliary device interactions or controls, suggestions, promotions, or the like. It is understood that the virtual assistant system may interact with the user to receive and provide data over multiple channels, and in some embodiments may receive or provide such data over multiple channels simultaneously. In some embodiments, the system may receive and convert audio data from the user via a speech-to-text algorithm that analyzes the audio signature of the user's voice. In other embodiments, the virtual assistant may receive data in the form of text from the user and may analyze the syntax of the text in order to derive context and meaning. The system is designed as to provide continuity of user experiences across multiple channels by operatively connecting multiple devices and applying machine learning analysis on data from multiple channels in order to train and generate an adaptable machine learning model. For instance, in some embodiments, a conversation imitated by a user via a user device web application, or the like, may be used to inform later interactions with the customer via a second channel, such as via a phone call, textual chat, follow-up email, text message communication, or the like. In some embodiments, this continuity may be directly reflected in the data provided to the end user or customer, while in other embodiments suggestions for topics of conversation may be provided to an entity user in a customer support capacity such that the entity user may contextualize or anticipate what the customer or end user may need assistance with or may be interested in based on their previous communications with the virtual assistant and entity systems. In still further embodiments, the data may be received an analyzed by logging audio communications between one or more users and processing the audio communications to inform the virtual assistant system in order to anticipate the user's needs or interests.

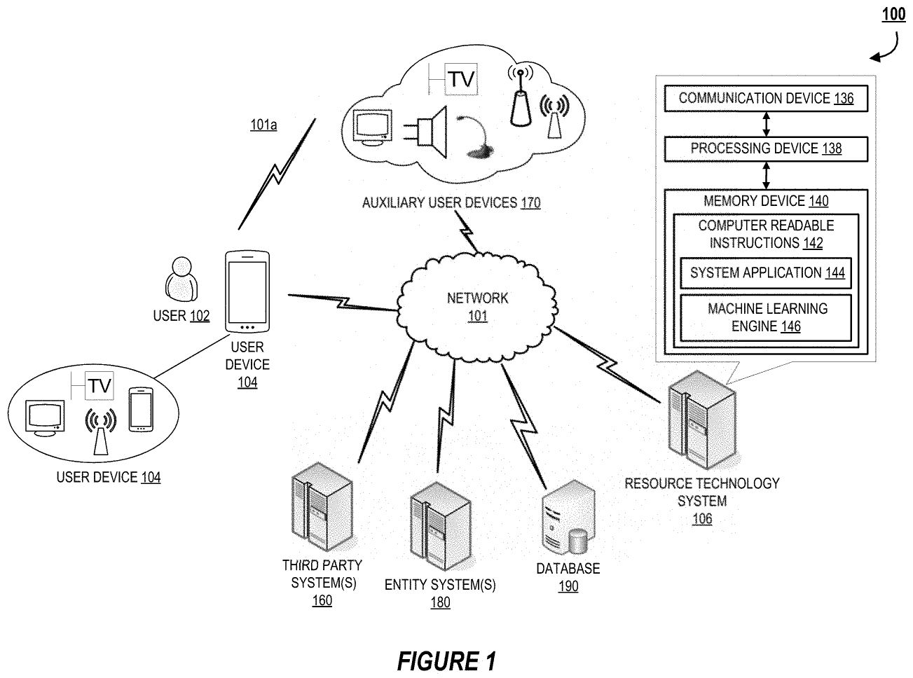

FIG. 1 depicts a platform environment 100 providing a system for multi-channel input and analysis, in accordance with one embodiment of the present invention. As illustrated in FIG. 1, a resource technology system 106, configured for providing an intelligent, proactive and responsive application or system, at a user device 104, which facilitates execution of electronic activities in an integrated manner. The resource technology system 106 is capable of adapting to the user's natural communication and its various modes by allowing seamless switching between communication channels/mediums in real time or near real time. The resource technology system is operatively coupled, via a network 101 to one or more user devices 104, auxiliary user devices 170, to entity systems 180, database 190, third party systems 160, and other external systems/third-party servers not illustrated herein. In this way, the resource technology system 106 can send information to and receive information from multiple user devices 104 and auxiliary user devices 170 to provide an integrated platform with multi-channel cognitive assistive capabilities to a user 102, and particularly to the user device 104. At least a portion of the system is typically configured to reside on the user device 104, on the resource technology system 106 (for example, at the system application 144), and/or on other devices and system and is an intelligent, proactive, responsive system that facilitates execution of intelligent communication in an integrated manner. Furthermore, the system is capable of seamlessly adapting to and switch between the user's natural communication and its various modes (such as speech or audio communication, textual communication in the user's preferred natural language, gestures and the like), and is typically infinitely customizable by the resource technology system 106 and/or the user 102.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. The network 101 is configured to establish an operative connection between otherwise incompatible devices, for example establishing a communication channel, automatically and in real time, between the one or more user devices 104 and one or more of the auxiliary user devices 170, (for example, based on reeving a user input, or when the user device 104 is within a predetermined proximity or broadcast range of the auxiliary user device(s) 170), as illustrated by communication channel 101a. Therefore, the system, via the network 101 may establish, operative connections between otherwise incompatible devices, for example by establishing a communication channel 101a between the one or more user devices 104 and the auxiliary user devices 170. In this regard, the network 101 (and particularly the communication channels 101a) may take the form of contactless interfaces, short range wireless transmission technology, such near-field communication (NFC) technology, Bluetooth® low energy (BLE) communication, audio frequency (AF) waves, wireless personal area network, radio-frequency (RF) technology, and/or other suitable communication channels. Tapping may include physically tapping the external apparatus, such as the user device 104, against an appropriate portion of the auxiliary user device 170 or it may include only waving or holding the external apparatus near an appropriate portion of the auxiliary user device without making physical contact with the auxiliary user device.

In some embodiments, the user 102 is an individual that wishes to conduct one or more activities with resource technology system 106 using the user device 104. In some embodiments, the user 102 may access the resource technology system 106, and/or the entity system 180 through a user interface comprising a webpage or a user application. Hereinafter, “user application” is used to refer to an application on the user device 104 of the user 102, a widget, a webpage accessed through a browser, and the like. As such, in some instances, the user device may have multiple user applications stored/installed on the user device 104. In some embodiments, the user application is a user application 538, also referred to as a “user application” herein, provided by and stored on the user device 104 by the resource technology system 106. In some embodiments the user application 538 may refer to a third party application or a user application stored on a cloud used to access the resource technology system 106 and/or the auxiliary user device 170 through the network 101, communicate with or receive and interpret signals from auxiliary user devices 170, and the like. In some embodiments, the user application is stored on the memory device of the resource technology system 106, and the user interface is presented on a display device of the user device 104, while in other embodiments, the user application is stored on the user device 104.

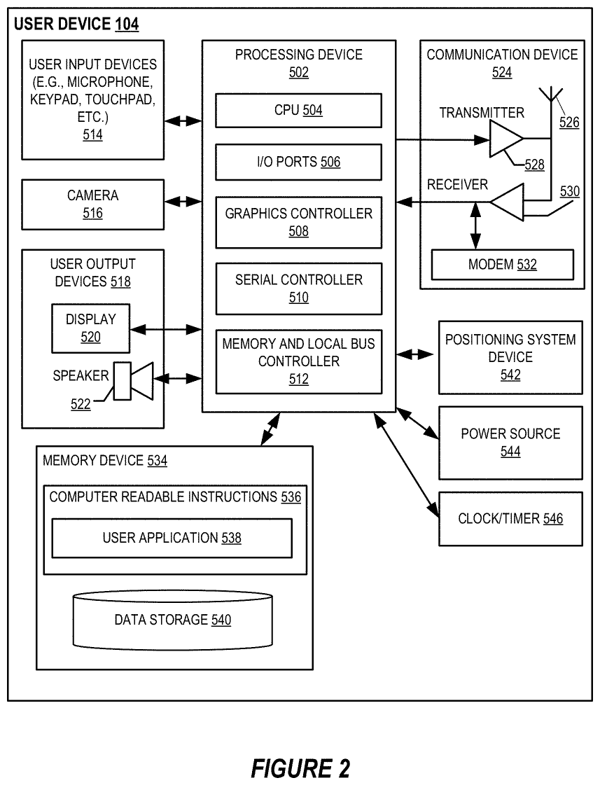

The user 102 may subsequently navigate through the interface or initiate one or more user activities or resource transfers using a central user interface provided by the user application 538 of the user device 104. In some embodiments, the user 102 may be routed to a particular destination or entity location using the user device 104. In some embodiments the auxiliary user device 170 requests and/or receives additional information from the resource technology system 106/the third party systems 160 and/or the user device 104 for authenticating the user and/or the user device, determining appropriate queues, executing information queries, and other functions. FIG. 2 provides a more in depth illustration of the user device 104.

As further illustrated in FIG. 1, the resource technology system 106 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the third party systems 160, auxiliary user devices 170 and/or the user device 104. As such, the communication device 136 generally comprises a modem, server, wireless transmitters or other devices for communicating with devices on the network 101. The memory device 140 typically comprises a non-transitory computer readable storage medium, comprising computer readable/executable instructions/code, such as the computer-readable instructions 142, as described below.

As further illustrated in FIG. 1, the resource technology system 106 comprises computer-readable instructions 142 or computer readable program code 142 stored in the memory device 140, which in one embodiment includes the computer-readable instructions 142 of a system application 144 (also referred to as a “system application” 144). The computer readable instructions 142, when executed by the processing device 138 are configured to cause the system 106/processing device 138 to perform one or more steps described in this disclosure to cause out systems/devices to perform one or more steps described herein. In some embodiments, the memory device 140 includes a data storage for storing data related to user transactions and resource entity information, but not limited to data created and/or used by the system application 144. Resource technology system 106 also includes machine learning engine 146. In some embodiments, the machine learning engine 146 is used to analyze received data in order to identify complex patterns and intelligently improve the efficiency and capability of the resource technology system 106 to analyze received voice print data and identify unique patterns. In some embodiments, the machine learning engine 146 may included supervised learning techniques, unsupervised learning techniques, or a combination of multiple machine learning models that combine supervised and unsupervised learning techniques. In some embodiments, the machine learning engine may include an adversarial neural network that uses a process of encoding and decoding in order to adversarial train one or more machine learning models to identify relevant patterns in received data received from one or more channels of communication.

FIG. 1 further illustrates one or more auxiliary user devices 170, in communication with the network 101. The auxiliary user devices 170 may comprise peripheral devices such as speakers, microphones, smart speakers, and the like, display devices, a desktop personal computer, a mobile system, such as a cellular phone, smart phone, personal data assistant (PDA), laptop, wearable device, a smart TV, a smart speaker, a home automation hub, augmented/virtual reality devices, or the like.

In the embodiment illustrated in FIG. 1, and described throughout much of this specification, a “system” configured for performing one or more steps described herein refers to the services provided to the user via the user application, that may perform one or more user activities either alone or in conjunction with the resource technology system 106, and specifically, the system application 144, one or more auxiliary user device 170, and the like in order to provide an intelligent and proactive virtual voice assistant.

Typically, the central user interface is a computer human interface, and specifically a natural language/conversation user interface provided by the resource technology system 106 to the user 102 via the user device 104 or auxiliary user device 170. The various user devices receive and transmit user input to the entity systems 180 and resource technology system 106. The user device 104 and auxiliary user devices 170 may also be used for presenting information regarding user activities, providing output to the user 102, and otherwise communicating with the user 102 in a natural language of the user 102, via suitable communication mediums such as audio, textual, and the like. The natural language of the user comprises linguistic variables such as words, phrases and clauses that are associated with the natural language of the user 102. The system is configured to receive, recognize and interpret these linguistic variables of the user input and perform user activities and resource activities accordingly. In this regard, the system is configured for natural language processing and computational linguistics. In many instances, the system is intuitive, and is configured to anticipate user requirements, data required for a particular activity and the like, and request activity data from the user 102 accordingly.

Also pictured in FIG. 1 are one or more third party systems 160, which are operatively connected to the resource technology system 106 via network 101 in order to transmit data associated with user activities, user authentication, user verification, resource actions, and the like. For instance, the capabilities of the resource technology system 106 may be leveraged in some embodiments by third party systems in order to authenticate user actions based on data provided by the third party systems 160, third party applications running on the user device 104 or auxiliary user devices 170, as analyzed and compared to data stored by the resource technology system 106, such as data stored in the database 190 or stored at entity systems 180. In some embodiments, the multi-channel cognitive processing capabilities may be provided as a service by the resource technology system 106 to the entity systems 180, third party systems 160, or additional systems and servers not pictured, through the use of an application programming interface (“API”) designed to simplify the communication protocol for client-side requests for data or services from the resource technology system 106. In this way, the capabilities offered by the present invention may be leveraged by multiple parties other than the those controlling the resource technology system 106 or entity systems 180.

FIG. 2 provides a block diagram of the user device 104, in accordance with one embodiment of the invention. The user device 104 may generally include a processing device or processor 502 communicably coupled to devices such as, a memory device 534, user output devices 518 (for example, a user display device 520, or a speaker 522), user input devices 514 (such as a microphone, keypad, touchpad, touch screen, and the like), a communication device or network interface device 524, a power source 544, a clock or other timer 546, a visual capture device such as a camera 516, a positioning system device 542, such as a geo-positioning system device like a GPS device, an accelerometer, and the like. The processing device 502 may further include a central processing unit 504, input/output (I/O) port controllers 506, a graphics controller or graphics processing device (GPU) 208, a serial bus controller 510 and a memory and local bus controller 512.

The processing device 502 may include functionality to operate one or more software programs or applications, which may be stored in the memory device 534. For example, the processing device 502 may be capable of operating applications such as the multi-channel resource application 122. The user application 538 may then allow the user device 104 to transmit and receive data and instructions from the other devices and systems of the environment 100. The user device 104 comprises computer-readable instructions 536 and data storage 540 stored in the memory device 534, which in one embodiment includes the computer-readable instructions 536 of a multi-channel resource application 122. In some embodiments, the user application 538 allows a user 102 to access and/or interact with other systems such as the entity system 180, third party system 160, or resource technology system 106. In one embodiment, the user 102 is a maintaining entity of a resource technology system 106, wherein the user application enables the user 102 to configure the resource technology system 106 or its components. In one embodiment, the user 102 is a customer of a financial entity and the user application 538 is an online banking application providing access to the entity system 180 wherein the user may interact with a resource account via a user interface of the multi-channel resource application 122, wherein the user interactions may be provided in a data stream as an input via multiple channels. In some embodiments, the user 102 may a customer of third party system 160 that requires the use or capabilities of the resource technology system 106 for authorization or verification purposes.

The processing device 502 may be configured to use the communication device 524 to communicate with one or more other devices on a network 101 such as, but not limited to the entity system 180 and the resource technology system 106. In this regard, the communication device 524 may include an antenna 526 operatively coupled to a transmitter 528 and a receiver 530 (together a “transceiver”), modem 532. The processing device 502 may be configured to provide signals to and receive signals from the transmitter 528 and receiver 530, respectively. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, millimeter wave technology communication protocols, and/or the like. The user device 104 may also be configured to operate in accordance with non-cellular communication mechanisms, such as via a wireless local area network (WLAN) or other communication/data networks. The user device 104 may also be configured to operate in accordance , audio frequency, ultrasound frequency, or other communication/data networks.

The user device 104 may also include a memory buffer, cache memory or temporary memory device operatively coupled to the processing device 502. Typically, one or more applications, are loaded into the temporarily memory during use. As used herein, memory may include any computer readable medium configured to store data, code, or other information. The memory device 534 may include volatile memory, such as volatile Random Access Memory (RAM) including a cache area for the temporary storage of data. The memory device 534 may also include non-volatile memory, which can be embedded and/or may be removable. The non-volatile memory may additionally or alternatively include an electrically erasable programmable read-only memory (EEPROM), flash memory or the like.

Though not shown in detail, the system further includes one or more entity systems 180 which is connected to the user device 104 and the resource technology system 106 and which may be associated with one or more entities, institutions, third party systems 160, or the like. In this way, while only one entity system 180 is illustrated in FIG. 1, it is understood that multiple networked systems may make up the system environment 100. The entity system 180 generally comprises a communication device, a processing device, and a memory device. The entity system 180 comprises computer-readable instructions stored in the memory device, which in one embodiment includes the computer-readable instructions of an entity application. The entity system 180 may communicate with the user device 104 and the resource technology system 106 to provide access to user accounts stored and maintained on the entity system 180. In some embodiments, the entity system 180 may communicate with the resource technology system 106 during an interaction with a user 102 in real-time, wherein user interactions may be logged and processed by the resource technology system 106 in order to analyze interactions with the user 102 and reconfigure the machine learning model in response to changes in a received or logged data stream. In one embodiment, the system is configured to receive data for decisioning, wherein the received data is processed and analyzed by the machine learning model to determine a conclusion. In some embodiments, communications between one or more users and one or more user devices is logged and used for decisioning and contextual analysis for further communication from the resource technology system 106 via an alternate communication channel (e.g., an audio conversation between a service representative and customer may be recorded for quality assurance purposes, converted using a speech-to-text algorithm, and analyzed using the machine learning engine 146 in order to inform later communications sent from the resource technology system 106 to the user device 104).

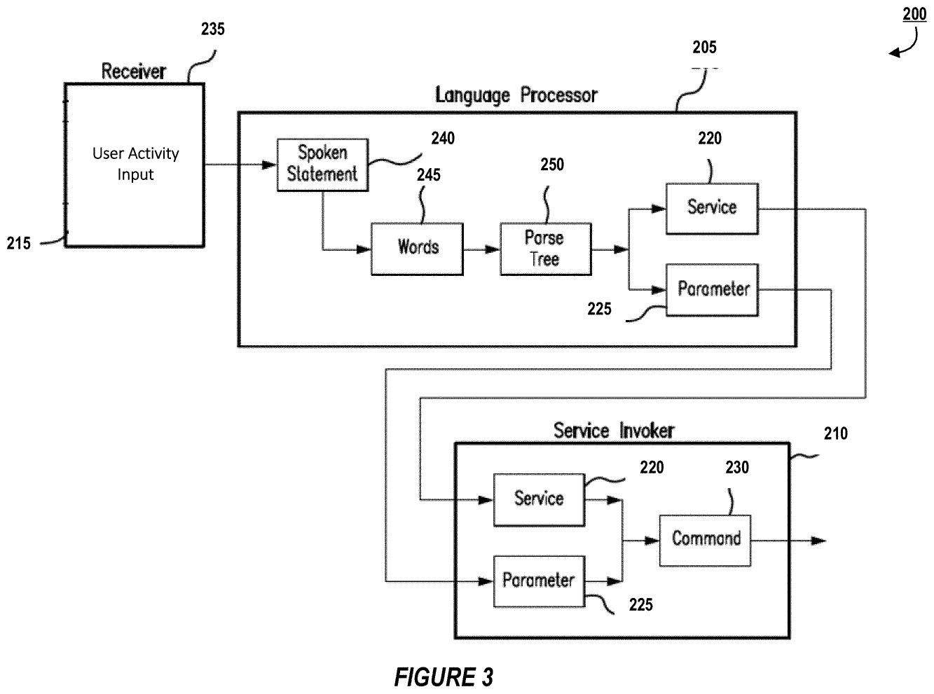

FIG. 3 depicts a high level process flow of a language processing module 200 of a multi-channel resource platform application, in accordance with one embodiment of the invention. The language processing module 100 is typically a part of the user application 538 of the user device, although in some instances the language processing module resides on the resource technology system 106. The natural language of the user may include linguistic variables such as verbs, phrases and clauses that are associated with the speech or written text produced by the user. The system, and the language processing module 200 in particular, is configured to receive, recognize and interpret these linguistic variables of the user input and infer context. In this regard, the language processing module 200 is configured for natural language processing and computational linguistics. As illustrated in the embodiment provided in FIG. 2, the language processing module 200 may include a receiver 235 (such as a microphone, a touch screen or another user input or output device), a language processor 205 and a service invoker 210. It is understood that these components may not exist in all embodiments, particularly in those where conversations between two human users are logged and later processed by the language processing module. The illustrative embodiment shown in FIG. 2 simply illustrates one means of input that the system may incorporate in order to receive data for linguistic processing.

As shown in FIG. 2, receiver 235 receives a user activity input 215 from the user, such as a spoken statement, provided using an audio communication medium. Although described in this particular embodiment in the context of an audio communication medium, the language processing module 200 is not limited to this medium and is configured to operate on input received through other mediums such as textual input, graphical input (such as sentences/phrases in images or videos), and the like. As an example, the user may provide an activity input comprising the sentence “I'm interested in product X.” The receiver 235 may receive the user activity input 215 and forward the user activity input 215 to the language processor 205. An example algorithm for the receiver 235 is as follows: wait for user activity input; receive user activity input; identify medium of user activity input as spoken statement; and forward spoken statement 240 to language processor 205.

The language processor 205 receives spoken statement 240 and processes spoken statement 240 to determine an appropriate service 220 to invoke to respond to the user activity input 215 and any parameters 225 needed to invoke service 220. The language processor 205 may detect a plurality of words 245 in spoken statement 240. Using the previous example, words 245 may include: interested, and product X. The language processor 205 may process the detected words 245 to determine the service 220 to invoke to respond to user activity input 215.

The language processor 205 may generate a parse tree based on the detected words 245. Parse tree may indicate the language structure of spoken statement 240. Using the previous example, parse tree may indicate a verb and infinitive combination of “interested” and an object of “product” with the modifier of “X.” The language processor 205 may then analyze the parse tree to determine the intent of the user and the activity associated with the conversation to be performed. For example, based on the example parse tree, the language processor 205 may determine that the user may be interested in purchasing a particular product or group of products related to product X. Facilitating the purchase of product X, or other associated products (e.g., products identified as being related to the same category of product X), may represent an identified service 220. For instance, if the user is identified as interested in purchasing a house or a car, the identified service 220 may be a loan. Additionally, the system may recognize that certain parameters 225 are required to complete the service 220, such as required authentication in order to initiate a resource transfer from a user account, and may identify these parameters 225 before forwarding information to the service invoker 210.

An example algorithm for the language processor 205 is as follows: wait for spoken statement 240; receive spoken statement 240 from receiver 235; parse spoken statement 240 to detect one or more words 245; generate parse tree using the words 245; detect an intent of the user by analyzing parse tree; use the detected intent to determine a service to invoke; identify values for parameters requires to complete the service 220; and forward service 220 and the values of parameters 225 to service invoker 210.

Next, the service invoker 210 receives determined service 220 comprising required functionality and the parameters 225 from the language processor 205. The service invoker 210 may analyze service 220 and the values of parameters 225 to generate a command 230. Command 230 may then be sent to instruct that service 220 be invoked using the values of parameters 225. In response, the language processor 205 may invoke a resource transfer functionality of a user application 538 of the user device, for example, by extracting pertinent elements and embedding them within the central user interface, or by requesting authentication information from the user via the central user interface. An example algorithm for service invoker 210 is as follows: wait for service 220; receive service 220 from the language processor 205; receive the values of parameters 225 from the language processor 205; generate a command 230 to invoke the received service 220 using the values of parameters 225; and communicate command 230 to invoke service 220.

In some embodiments, the system also includes a transmitter that transmits audible signals, such as questions, requests and confirmations, back to the user. For example, if the language processor 205 determines that there is not enough information in spoken statement 240 to determine which service 220 should be invoked, then the transmitter may communicate an audible question back to the user for the user to answer. The answer may be communicated as another spoken statement 240 that the language processor 205 can process to determine which service 220 should be invoked. As another example, the transmitter may communicate a textual request back to the user. If the language processor 205 determines that certain parameters 225 are needed to invoke a determined service 220 but that the user has not provided the values of these parameters 225. For example, if the user had initially stated “I want to purchase product x,” the language processor 205 may determine that certain values for service 220 are missing. In response, the transmitter may communicate the audible request “how many/much of product X would you like to purchase?” As yet another example, the transmitter may communicate an audible confirmation that the determined service 220 has been invoked. Using the previous example, the transmitter may communicate an audible confirmation stating “Great, let me initiate that transaction.” In this manner, the system may dynamically interact with the user to determine the appropriate service 220 to invoke to respond to the user.

In other embodiments, the spoken statement 240 may be contextualized and mapped based on other user input, such as input from a second user. For example, in an embodiment where the system logs a conversation between a customer (“first user”) and a service representative of the entity (“second user”), the system may map certain information provided by the first user to a use case, data category, data retrieval process, or the like. This process may occur in tandem with the analysis of the audio input data or spoken statement 240 as previously described. For example, the system may employ the use of linguistic analysis to infer a contextual significance of a question from the second user to the first user, and may identify the response as containing the answer to the question (e.g., an agent or service representative may ask a customer for their customer identification code, and the customer may respond in natural language with their user identification code, user name, or the like). In this case, while the system may infer the context of the conversation between the first user and the second user via linguistic analysis, the system may also parse this information and map the identified question and answer data to an alphanumeric number and software service call (e.g., a customer response containing a username may be mapped to a software service call “retrieveCustomerDetails”). In this way, the system may employ the use of the software service call to later retrieve information already provided by the user during a logged conversation in order to enhance the user experience in interacting with the virtual assistant at a later time.

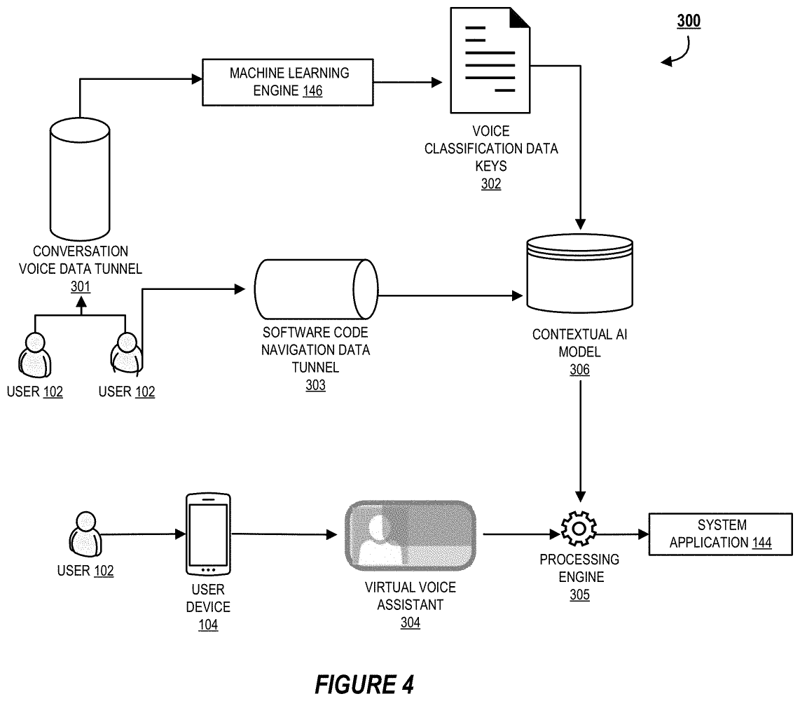

FIG. 4 depicts a high-level process flow 300 for intelligent voice assistant training, in accordance with one embodiment of the present invention. Although, the high-level process flow 300 is described with respect to a user mobile device, it is understood that the process flow is applicable to a variety of other user devices, such as a voice controlled smart home device. Furthermore, one or more steps described herein may be performed by the user device 104, user application 538, and/or the resource technology system 106. The user application 538 stored on a user mobile device, is typically configured to launch, control, modify and operate applications stored on the mobile device. In this regard, the user application 538 facilitates the user 102 to perform an activity or retrieve information.

As such, the process flow begins at the user 102 where data is provided to the system components for analysis and processing via one or more of multiple channels. As shown in the particular embodiment illustrated in FIG. 4, the user 102 may represent one or more users acting in various capacities. For instance, the user 102 may be a customer, or the like, which provides voice data to the system via the conversation voice data tunnel 301. In other embodiments, the user 102 may be a system administrator, service representative, customer care representative, entity employee, or the like, whom provides data to the system either through the conversation voice data tunnel 301, or through a software code navigation data tunnel 303. In this way, the system may log data received via the conversation voice data tunnel between (e.g., recorded audio of a conversation between two users, or the like), and process the data via linguistic analysis. Additionally, the system may map the data received via the conversation voice data tunnel 301 to data received via the software code navigation data tunnel (e.g., the system may map a data entry for a software command such as “retrieveCustomerDetails” with the audio or voice data received via the conversation voice data tunnel, or the like). In this way, the system may build a growing database of voice print and conversation data received for the conversation data tunnel 301 and not only contextualize it based on the syntax and linguistic variables of the logged conversation alone, but also build software pathways that map the contextual data to certain information retrieval or storage processes for later reference. This allows the system to proactively retrieve certain information, recommend information, store information, or otherwise utilize information when a customer or other user interacts with the system at a later time, and creates a more efficient means of communication with the user by providing continuity of conversational topic, or the like, and also avoiding situations in which the user may have to repeat the process of providing the same information repeatedly via multiple channels in regard to the same task, topic, conversation, or the like.

As shown the system uses the data received via multiple channels via the conversation voice data tunnel 301 to create a voice print for each individual user by analysis via the machine learning engine 146 and the contextual AI model 306, the data of which is stored as voice classification data keys 302. For instance, audio information from the conversation voice data tunnel 301 may be analyzed via the machine learning engine 146 not only in terms of linguistic analysis as covered in FIG. 3, but also in terms of a voice print analysis given that each unique user 102 should be expected to have a corresponding uniqueness in their voice data that may be used to either identify the user or increase the accuracy of speech-to-text translation over time. For instance, the machine learning engine 146 may be used to analyze the frequency pattern of the logged audio data received from the conversation voice data tunnel in order to identify and extract recurring patterns from the frequency data and learn over time to associate those patterns with a particular user. This data is stored as a voice classification data key 302 on a user by user basis. For example, the particular user may have a particular accent, cadence, pattern of pronunciation, or the like which is indicated by the frequency wave pattern of the recorded audio of their speech.

Raw pattern analysis may be useful in determining authentication, validation, or authorization information that can be used to identify a given user by their voice alone. For instance, a certain pattern of frequencies, cadence, pitch, tone, dialect, or the like, may be used to determine an overall biometric “fingerprint” of a user's voice data regardless of the contextual significance or substantive meaning of the audio itself. However, the system may also more accurately map such patterns to their contextual significance using the contextual artificial intelligence (AI) model 306. The contextual AI model 306 may incorporate one or more machine learning engines, neural networks, or the like, in order to intelligently infer or verify the context of certain audio frequency patterns extracted by the machine learning engine 146. While the machine learning engine 146 may generally infer that a particular audio wave frequency data segment may represent a certain word, phrase, or the like, according to a broad-based general speech-to-text conversion algorithm trained using a group of disparate user data, the contextual AI model 306 may be used to tailor the particular voice classification data key for a particular user. For example, the machine learning engine 146 may determine that the audio frequency data segment corresponds to multiple possible words or phrases, and the contextual AI model may receive context via the software code navigation data tunnel in order to verify which of the possible words or phrases is in fact accurate (e.g., possible words or phrases identified by the machine learning engine 146 may include username, first name, last name, or the like, and the contextual AI model 306 may confirm that the most accurate possibility is “username,” according to input data received via the software code navigation data tunnel 303 immediately following, in response to, or during the time stamped timeframe of the audio frequency data segment in question). It is understood that this process is dynamic and ongoing, such that any contextual significance received by the contextual AI model 306 may be used to further enhance the accuracy of the voice classification data keys 302.

It is also understood that certain contextual significance of communication between one or more users may be extrapolated and used to inform the models as a whole, as opposed to simply improving the accuracy of the voice classification data keys for a particular user alone. There may be certain contextual patterns that arise frequently (as defined by a given threshold, or statistically significant standard of deviation), across a dataset of conversations between one or more multiple different customers and the services representatives they interact with. For instance, the contextual AI model 306 may identify certain patterns of response to certain questions or recommendations from the service representative. In some embodiments, it may be that users sharing certain data characteristics tend to respond in a certain manner, while users sharing other characteristics tend to respond in a different manner. For instance, users in a certain geographic location may tend to show interest in a particular product provided by or suggested by the service representative, while users in second geographic location do not. This data may be used to inform a virtual voice assistant 304 to more proactively engage with users and provide relevant suggestions, manners of communication, methods of response, phrasing of response, or the like, which are recognized as being most effective or preferred by the users showing certain characteristics mapped to those inferred preferences. In this way, not only may the virtual voice assistant 304 access and provide information already collected during a conversation between two human users, but may also actively avoid or include certain information, phraseology, or the like, that the system infers fit the user's preference as extrapolated from a wide dataset of all user interactions, not just interactions involving that particular user. In this way, the manner in which the virtual voice assistant 304 interacts with the user may change intelligently based on characteristics of that user (e.g., geographic area, life stage, or the like). In some instances, the contextual AI model 306 may determine that certain phraseology is non-preferential to a wide range of users, and may proactively adapt to avoid such phraseology all-together. In this way, the virtual voice assistant 304 may be intelligently programmed to elicit positive or preferred responses from users over time in an automated fashion as more data is collected an analyzed by the system.

Data may be provided by these discussed components to the downstream processing engine 305, which interacts with both the system application 144 and the virtual voice assistant 304 in order to intelligently interact with the user 102 via a separate channel, such as through a text chat window, artificial voice model, or the like, (depending on the channel of communication initiated by the user) on the user device 104. In this way, data received from the user 102 via the conversation data tunnel 301, or software code navigation data tunnel 303, may be used to contextualize the conversational tone and substantive information offered in response to the user or proactively recommended to the user via the virtual voice assistant 304. In this way, the system may provide continuity of conversational topics with the user over time via multiple channels such that the user may feel more familiar with the system's responses regardless of the channel in which they use to interact with the system. In the same fashion, the user may also avoid having to input information via the user device to the virtual voice assistant 304 that they have already previously provided by virtue of the system's ability to map software service calls to certain user response data.

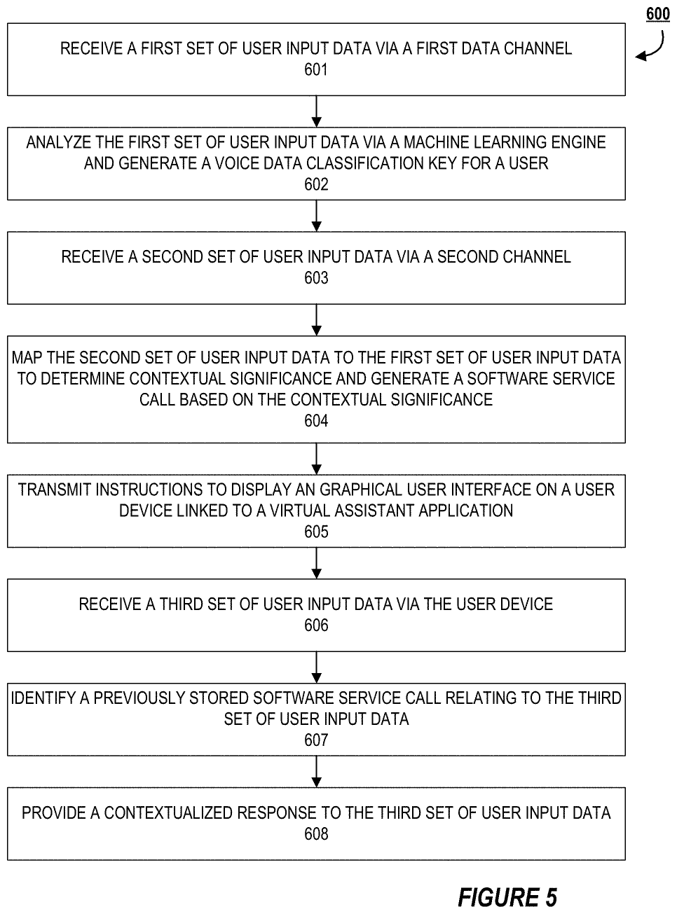

FIG. 5 depicts a high-level process flow 600 for intelligent voice assistant implementation, in accordance with one embodiment of the present invention. As shown, the process begins wherein the system receives a first set of user input data via a first data channel, such as an audio channel via a user device 104. For instance, as shown in FIG. 4, the system may receive audio data from any number of users via the conversation voice data tunnel 301. Next, as shown in block 602, the system analyzes the first set of user input data via a machine learning model, such as the machine learning engine 146, in order to generate a voice data classification key for a user, as describe in further detail with regard to the linguistic analysis of audio data covered in FIGS. 3 and 4. Next, the system may receives a second set of user input data via a second channel or via a second user device, such as via the software code navigation data tunnel 303. In this way, the system may log data received via the conversation voice data tunnel between (e.g., recorded audio of a conversation between two users, or the like), and process the data via linguistic analysis. Additionally, the system may map the data received via the conversation voice data tunnel 301, or the “first data channel” to data received via the software code navigation data tunnel, or the “second data channel” (e.g., the system may map a data entry for a software command such as “retrieveCustomerDetails” with the audio or voice data received via the conversation voice data tunnel, or the like). In this way, the system may build a growing database of voice print and conversation data received for the conversation data tunnel 301 and not only contextualize it based on the syntax and linguistic variables of the logged conversation alone, but also build software pathways that map the contextual data to certain information retrieval or storage processes for later reference, as shown in block 604.

Next, as shown in block 605, the system may transmit instructions to display a graphical user interface on a user device 104, such as via user application 538, in order to provide access to the virtual voice assistant 304. The user application 538 may comprise an embedded virtual voice assistant 304 that operates according to locally stored instructions on the user device, while in other embodiments, the virtual voice assistant 304 may reside on the resource technology system 106, and may be linked to the user application 538 over network 101 as a “cloud service” or the like. The system may then receive a third set of user input data via the user device through any number of communication channels, depending on the how the user chooses to interact with the virtual voice assistant 304 (e.g., voice communication, text chat communication, or the like), as shown in block 606. The system may then identify the previously stored software service call relating to the third set of user input, as shown in block 607, and provide a contextualized response to the third set of user input data, as shown in block 608. As described with regard to FIG. 4, this is simply one embodiment wherein the user may avoid having to repeat the input of data previously provided via a separate channel of communication. However, it is understood that the contextualized response to the third set of user input data may be based on prior communication with the particular user, or may be intelligently generated based on context deemed appropriate according to extrapolation of more generalized user patterns or user characteristic data by the contextual AI model 306.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for a multi-channel intelligent virtual assistant, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
provide a multi-channel resource application on a user device associated with a user, wherein the multi-channel resource application is configured to present a central user interface on a display device of the user device;
receive a first set of user input data via a first data channel;
analyze the first set of user input data via a machine learning engine and generate a voice data classification key for the user;
receive a second set of user input data via a second channel;
map the second set of user input data to the first set of user input data to determine contextual significance and generate a software service call for the contextual significance;
receive a third set of user input data via third communication channel from the user device;
identify a previously stored software service call relating to the third set of user input data; and
provide a contextualized response to the third set of user input data via the multi-channel resource application on the user device.

2. The system of claim 1, wherein the first data channel is an audio communication channel established via a conversation voice data tunnel between the user and the multi-channel intelligent virtual assistant.

3. The system of claim 1, wherein the second data channel is a software input data channel established via a software code navigation data tunnel between a second user and a contextual artificial intelligence model.

4. The system of claim 1, wherein the third data channel is a text communication channel established via the user device and a remote virtual assistant processing engine.

5. The system of claim 1, wherein the voice data classification key further comprises a data store of unique frequency patterns of logged audio data received from the user as determined by analysis via a machine learning engine.

6. The system of claim 1, wherein the contextualized response to the third set of user input data is further based on extrapolated inferences of user preferences based on a set of user data of multiple users sharing one or more characteristics with the user.

7. The system of claim 1, wherein the multi-channel intelligent virtual assistant is stored on a remote server and provided via the user device as a cloud-based service.

8. A computer program product for a multi-channel intelligent virtual assistant, the computer program product comprising a non-transitory computer-readable storage medium having computer-executable instructions to:
provide a multi-channel resource application on a user device associated with a user, wherein the multi-channel resource application is configured to present a central user interface on a display device of the user device;
receive a first set of user input data via a first data channel;
analyze the first set of user input data via a machine learning engine and generate a voice data classification key for the user;
receive a second set of user input data via a second channel;
map the second set of user input data to the first set of user input data to determine contextual significance and generate a software service call for the contextual significance;
receive a third set of user input data via third communication channel from the user device;
identify a previously stored software service call relating to the third set of user input data; and
provide a contextualized response to the third set of user input data via the multi-channel resource application on the user device.

9. The computer program product of claim 8, wherein the first data channel is an audio communication channel established via a conversation voice data tunnel between the user and the multi-channel intelligent virtual assistant.

10. The computer program product of claim 8, wherein the second data channel is a software input data channel established via a software code navigation data tunnel between a second user and a contextual artificial intelligence model.

11. The computer program product of claim 8, wherein the third data channel is a text communication channel established via the user device and a remote virtual assistant processing engine.

12. The computer program product of claim 8, wherein the voice data classification key further comprises a data store of unique frequency patterns of logged audio data received from the user as determined by analysis via a machine learning engine.

13. The computer program product of claim 8, wherein the contextualized response to the third set of user input data is further based on extrapolated inferences of user preferences based on a set of user data of multiple users sharing one or more characteristics with the user.

14. The computer program product of claim 8, wherein the multi-channel intelligent virtual assistant is stored on a remote server and provided via the user device as a cloud-based service.

15. A computer implemented method for a multi-channel intelligent virtual assistant, the computer implemented method comprising:
providing a computing system comprising a computer processing device and a non-transitory computer readable medium, where the non-transitory computer readable medium comprises configured computer program instruction code, such that when said instruction code is operated by said computer processing device, said computer processing device performs the following operations:
providing a multi-channel resource application on a user device associated with a user, wherein the multi-channel resource application is configured to present a central user interface on a display device of the user device;
receiving a first set of user input data via a first data channel;
analyzing the first set of user input data via a machine learning engine and generate a voice data classification key for the user;
receiving a second set of user input data via a second channel;
mapping the second set of user input data to the first set of user input data to determine contextual significance and generate a software service call for the contextual significance;
receiving a third set of user input data via third communication channel from the user device;
identifying a previously stored software service call relating to the third set of user input data; and
providing a contextualized response to the third set of user input data via the multi-channel resource application on the user device.

16. The computer implemented method of claim 15, wherein the first data channel is an audio communication channel established via a conversation voice data tunnel between the user and the multi-channel intelligent virtual assistant.

17. The computer implemented method of claim 15, wherein the second data channel is a software input data channel established via a software code navigation data tunnel between a second user and a contextual artificial intelligence model.

18. The computer implemented method of claim 15, wherein the third data channel is a text communication channel established via the user device and a remote virtual assistant processing engine.

19. The computer implemented method of claim 15, wherein the voice data classification key further comprises a data store of unique frequency patterns of logged audio data received from the user as determined by analysis via a machine learning engine.

20. The computer implemented method of claim 15, wherein the contextualized response to the third set of user input data is further based on extrapolated inferences of user preferences based on a set of user data of multiple users sharing one or more characteristics with the user.
